(19) United States
(12) Patent Application Publication
(10) Pub. No.: US 2005/0225504 A1
(43) Pub. Date: Oct. 13, 2005

(54) Plasma display panel (PDP) and method of driving PDP

(76) Inventor: Sang-Chul Kim, Suwon-si (KR)

Correspondence Address: Robert E. Bushnell, Suite 300, 1522 K Street, N.W., Washington, DC, 20005-1202, US

(21) Appl. No.: 11/099,471

(22) Filed: Apr. 6, 2005

(30) Foreign Application Priority Data
Apr. 12, 2004 (KR) 10-2004-0024874
Jun. 30, 2004 (KR) 10-2004-0050888

(51) Int. Cl. G09G 3/28

(52) U.S. Cl. 345/60

(57) ABSTRACT

In a Plasma Display Panel (PDP), during an address period, a plurality of scan electrodes are divided into a plurality of groups having a first and a second group, and, during an address period, a first scan pulse and a second scan pulse succeeding the first scan pulse are supplied to at least one scan electrode among the first group of scan electrodes. The first scan pulse is supplied to at least one scan electrode among the second group of scan electrodes while the second pulse is supplied to at least one scan electrode among the first group of scan electrodes, and the second scan pulse succeeding the first scan pulse is supplied to at least one scan electrode among the second group of scan electrodes.

### CLAIM OF PRIORITY

This application makes reference to, incorporates the same herein, and claims all benefits accruing under 35 U.S.C. §119 from an application earlier filed in the Korean Intellectual Property Office on 12 Apr. 2004 and 30 Jun. 2004 and there duly assigned Serial Nos. 10-2004-0024874 and 10-2004-0050888 respectively.

### BACKGROUND OF THE INVENTION

1. Field of the Invention

The present invention relates to a Plasma Display Panel (PDP) and a method of driving the PDP.

2. Description of the Related Art

A PDP is a flat panel display for presenting characters or images using a plasma generated by a gas discharge, and includes hundreds of thousands to millions of pixels arranged in a matrix format, in which the number of pixels are determined by the size of the PDP. The PDP is divided into a DC PDP and an AC PDP according to the supplied driving voltage waveforms and the structure of the discharge cells.

DC PDP electrodes are exposed in a discharge space. A current flows in the discharge space when a voltage is supplied. There is a problem in that a resistor must be provided for current limitation. On the other hand, AC PDP electrodes are covered by a dielectric layer. The current is limited because capacitance components are inherently formed. This results in a life span of the AC PDP being longer than that of the DC PDP.

Scan electrodes and sustain electrodes are formed in parallel on one side of the AC plasma display panel, and address electrodes crossing the scan electrodes and the sustain electrodes are formed on the other side of the plasma display panel. The sustain electrodes are formed corresponding to the scan electrodes, and a terminal of each sustain electrode is coupled to the other sustain electrodes in common.

Each subfield of a PDP has a reset period Pᵣ, an address period Pₐ, and a sustain period Pₛ.

In the reset period Pᵣ, wall charges formed by a previous sustain-discharge are eliminated, and wall charges are established for a next stable address discharge. In the address period Pₐ, cells which are turned on and cells which are not turned on in the panel are selected, and the wall charges are accumulated in the turned on cells (addressed cells). In the sustain period Pₛ, a sustain-discharge is performed for actually displaying an image on the addressed cells.

In the address period Pₐ of the driving waveform of a PDP, a scan pulse and an address pulse are supplied to a scan electrode Y and an address electrode A in order to select a discharge cell to be displayed. The scan pulse selects the scan electrode Y by sequentially supplying a voltage of V_{scL1} to the scan electrode Y for a predetermined time t1 while other scan electrodes are maintained at a voltage of V_{scH}. The address pulse supplies an address voltage Vₐ to the address electrode A which forms the discharge cell to be selected from the discharge cells formed by the scan electrode Y in which the voltage of V_{scL1} is supplied. Accordingly, an address discharge is generated by a difference between the voltage of Vₐ supplied to the address electrode A and the voltage of V_{scH} supplied to the scan electrode Y.

While a switch Y_{H} is turned on and other scan electrodes are maintained at the voltage of V_{scH} for the purpose of supplying the scan pulse to the scan electrode Y, a switch SW1 is turned on to transmit the voltage of V_{scH} to a terminal of Vₛₛ of a scan IC, a switch Y_{L} is turned on to sequentially supply the voltage of V_{scH} to the scan electrode Y, and the scan electrode is selected. Scan electrodes are sequentially scanned from a first scan electrode Y₁ to a last scan electrode Yₙ.

In the above method, it takes longer to supply the scan pulse from the first scan electrode Y₁ to the last scan electrode Yₙ when the single driving scan method is used in the high definition (HD) PDP which has a large number of scan lines. The width of the scan pulse is reduced in the case of the single scan operation of the HD PDP because the sustain period for performing a display discharge is reduced when the address period is increased. In addition, image quality of the display panel is deteriorated because the address discharge is unstable when the width of the scan pulse is reduced. That is, there is a problem in that the cells to be displayed may not be turned on.

### SUMMARY OF THE INVENTION

An object of the present invention is to provide a PDP which stably generates address discharges, and another object of the present invention is to provide a method of driving the PDP.

These and other objects of the present invention can be achieved by providing a method of driving a Plasma Display Panel (PDP), the method comprising: forming discharge cells with a plurality of scan electrodes and a plurality of address electrodes arranged in a direction perpendicular to the scan electrodes; dividing the plurality of scan electrodes into a plurality of groups including a first group and a second group; supplying, during an address period, a first scan pulse to at least one scan electrode among the scan electrodes of the first group; supplying, during the address period, a second scan pulse succeeding the first scan pulse to at least one scan electrode among the scan electrodes of the first group; supplying the first scan pulse to at least one scan electrode among the scan electrodes of the second group while the second scan pulse is being supplied to at least one scan electrode among the scan electrodes of the first group; and supplying the second scan pulse succeeding the first scan pulse to at least one scan electrode among the scan electrodes of the second group.

The second scan pulse preferably has a pulse width equal to a pulse width of the first scan pulse. Alternatively the second scan pulse preferably has a pulse width greater than a pulse width of the first scan pulse.

The first and second groups preferably respectively include a plurality of neighboring scan electrodes.

The scan electrodes of the first group are preferably even numbered scan electrodes, and the scan electrodes of the second group are preferably odd numbered scan electrodes.

The first scan pulse together with an address pulse supplied to the address electrode preferably is sufficient to generate an address discharge and the second scan pulse together with the address pulse supplied to the address electrode preferably is insufficient to generate the address discharge.

These and other objects of the present invention can also be achieved by providing a Plasma Display Panel (PDP) comprising: a display panel including a plurality of scan electrodes and a plurality of address electrodes, the plurality of scan electrodes being divided into a plurality of groups including a first group and a second group; and a plurality of selection circuits respectively coupled to the scan electrodes of the first and the second groups among the plurality of scan electrodes; wherein the respective selection circuits of the first group among the plurality of selection circuits coupled to the scan electrodes of the first group among the plurality of scan electrodes include a first switch coupled between a first voltage source adapted to supply a first voltage and the scan electrode, and a second switch coupled between the scan electrode and a second voltage source adapted to selectively supply one of a second and a third voltage; and wherein the second switch is adapted to selectively supply one of the second and third voltages to the scan electrode upon the scan electrode being selected, and the first switch is adapted to supply the first voltage to the scan electrode upon the scan electrode not being selected.

The respective selection circuits among the plurality of selection circuits coupled to the respective scan electrodes of the second group among the plurality of scan electrodes each preferably comprise: a third switch coupled between a third voltage source adapted to supply a fourth voltage and the scan electrode; and a fourth switch coupled between the scan electrode and a fourth voltage source adapted to supply a one of a fifth and a sixth voltage; and wherein the third switch voltage source is adapted to selectively supply one of the fifth and sixth voltages to the scan electrode upon the scan electrode being selected, and the fourth switch is adapted to supply the fourth voltage to the scan electrode upon the scan electrode not being selected.

A first time period for supplying the third voltage to at least one scan electrode among the scan electrodes of the first group preferably partially overlaps a second time period for supplying the fifth voltage to at least one scan electrode among the scan electrodes of the second group.

The first time period is preferably equal to the second time period. Alternatively, the first time period is preferably greater than the second time period.

The second voltage is preferably equal to the fifth voltage and the third voltage is preferably equal to the sixth voltage.

The second voltage and the fifth voltage together with an address voltage supplied to the address electrode preferably is sufficient to generate a discharge and the third voltage and the sixth voltage together with the address voltage supplied to the address electrode preferably is insufficient to generate the discharge.

The first group and the second group preferably respectively comprise even numbered scan electrodes and odd numbered scan electrodes.

The first group and the second group preferably respectively comprise a plurality of neighboring scan electrodes.

These and other objects of the present invention can further be achieved by providing a Plasma Display Panel (PDP) comprising: a display panel including a plurality of scan electrodes and a plurality of address electrodes, the plurality of scan electrodes being divided into a plurality of groups including a first group and a second group, the respective groups including a plurality of neighboring scan electrodes; a selection circuit of a first group adapted to be coupled to the scan electrode of the first group among the plurality of scan electrodes; a selection circuit of a second group adapted to be coupled to the scan electrode of the second group among the plurality of scan electrodes; a first driving circuit adapted to supply a first voltage to the scan electrode of a discharge cell to be turned on among the scan electrodes of the first group via the selection circuit of the first group, and to supply a second voltage which is higher than the first voltage to the scan electrode during an address period; and a second driving circuit adapted to supply the first voltage to the scan electrode of a discharge cell to be turned on among the scan electrodes of the second group via the selection circuit of the second group, and to supply the second voltage to the scan electrode during the address period; wherein a time period for supplying the second voltage to the scan electrode of the discharge cell to be turned on among the scan electrodes of the first group partially overlaps a time period for supplying the first voltage to the scan electrodes of the scan electrode of the discharge cell to be turned on among the scan electrodes of the second group.

The respective selection circuits of the first group and the second group each preferably comprise: a first switch adapted to be coupled between the scan electrode of the first group and a node between a third switch adapted to be coupled to a first voltage source and a fourth switch adapted to be coupled to a second voltage source, and the first switch adapted to be coupled between the scan electrode of the second group and a node between a fifth switch adapted to be coupled to the first voltage source and a sixth switch adapted to be coupled to the second voltage source; and a second switch adapted to be coupled between a third voltage source for supplying the third voltage and the scan electrodes of the first group and the second group; wherein the first driving circuit includes the third switch adapted to be coupled between the first switch of the selection circuit of the first group and the first voltage source adapted to supply the first voltage, and the fourth switch adapted to be coupled between the first switch of the selection circuit of the first group and the second voltage source adapted to supply the second voltage; wherein the second driving circuit includes the fifth switch adapted to be coupled between the first switch of the selection circuit of the second group and the first voltage source, and the sixth switch adapted to be coupled between the first switch of the selection circuit of the second group and the second voltage source; wherein the second switch is adapted to be turned on to supply the third voltage to the scan electrode upon the scan electrode not being selected; wherein the first switch of the selection circuit of the first group is adapted to be turned on and the third and fourth switches are adapted to be selectively turned on to selectively transmit one of the first and second voltages to the scan electrode of the first group upon the scan electrode being selected; and wherein the first switch of the selection circuit of the second group is adapted to be turned on and the fifth and the sixth switches are adapted to be selectively turned on to selectively transmit one of the first and second voltages to the scan electrodes of the second group upon the scan electrode being selected.

A first time period for turning on the fourth switch upon the scan electrode of the first group being selected preferably partially overlaps a second time period for turning on the fifth switch upon the scan electrode of the second group being selected.

The first time period is preferably equal to the second time period. Alternatively, the first time period is preferably greater than the second time period.

The first voltage together with the address voltage supplied to an address electrode of the discharge cell to be turned on preferably is sufficient to generate a discharge and the second voltage together with the address voltage preferably is insufficient to generate the discharge.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of driving waveforms of a PDP.

FIG. 2 is a block diagram of a scan Integrated Circuit (IC) for generating a waveform in an address period of the driving waveforms of FIG. 1.

FIG. 3 is a block diagram of a PDP according to an exemplary embodiment of the present invention.

FIG. 4 is a view of driving waveforms of the PDP according to a first exemplary embodiment of the present invention.

FIG. 5A and FIG. 5B are block diagrams of respective scan driving circuits including the scan ICs for scan electrodes of a first group and a second group according to the first exemplary embodiment of the present invention.

FIG. 6A and FIG. 6B respectively are detailed circuit diagrams of the scan ICs of FIG. 5A and FIG. 5B.

FIG. 7 is a timing chart of the scan ICs for the scan electrodes of the first group and the second group.

FIG. 8A and FIG. 8B respectively are detailed circuit diagrams of the scan driving circuits including the scan ICs for scan electrodes of the first group and the second group according to a second exemplary embodiment of the present invention.

FIG. 9 is a timing chart of the scan driving circuits of FIG. 8A and FIG. 8B.

FIG. 10 is a view of driving waveforms of the PDP according to the second exemplary embodiment of the present invention.

FIG. 11A and FIG. 11B respectively are detailed circuit diagrams of the scan driving circuits including the scan ICs for scan electrodes of the first group and the second group according to a third exemplary embodiment of the present invention.

FIG. 12 is a view of driving waveforms of the PDP according to the third exemplary embodiment of the present invention.

FIG. 13 is a timing chart of the scan driving circuits of FIG. 8A and FIG. 8B for generating the driving waveforms of FIG. 12 according to the second exemplary embodiment.

FIG. 14A and FIG. 14B respectively are detailed circuit diagrams of the scan driving circuits including the scan ICs for scan electrodes of the first group and the second group according to a fourth exemplary embodiment of the present invention.

### DETAILED DESCRIPTION OF THE INVENTION

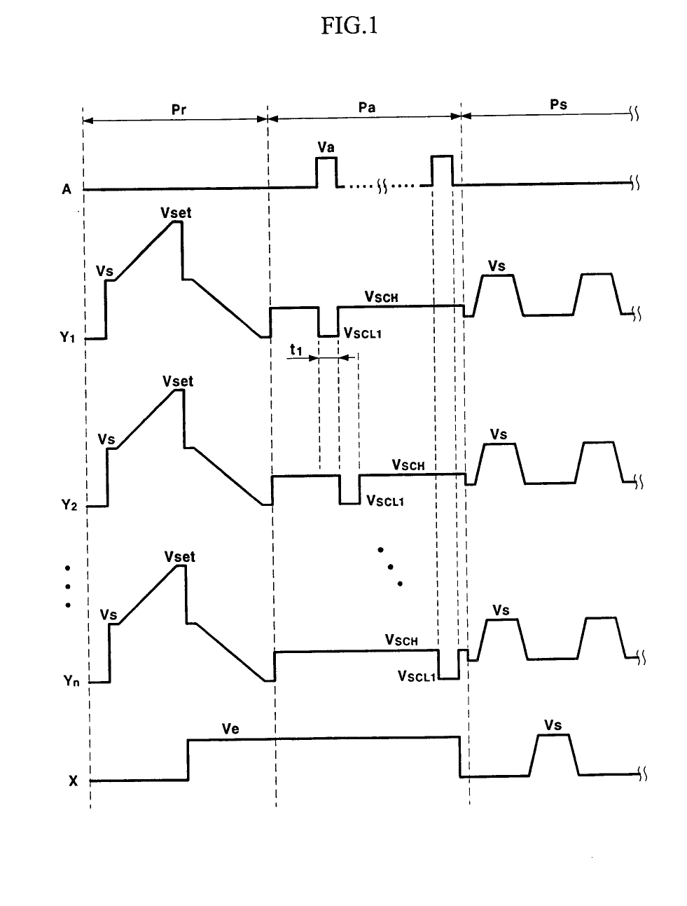

FIG. 1 is a view of driving waveforms of a PDP.

As shown in FIG. 1, each subfield has a reset period Pᵣ, an address period Pₐ, and a sustain period Pₛ according to a method for driving the plasma display panel.

In the reset period Pᵣ, wall charges formed by a previous sustain-discharge are eliminated, and wall charges are established for a next stable address discharge. In the address period Pₐ, cells which are turned on and cells which are not turned on in the panel are selected, and the wall charges are accumulated in the turned on cells (addressed cells). In the sustain period Pₛ, a sustain-discharge is performed for actually displaying an image on the addressed cells.

In the address period Pₐ of the driving waveform of a PDP, a scan pulse and an address pulse are supplied to a scan electrode Y and an address electrode A in order to select a discharge cell to be displayed. The scan pulse selects the scan electrode Y by sequentially supplying a voltage of V_{scL1} to the scan electrode Y for a predetermined time t1 while other scan electrodes are maintained at a voltage of V_{scH}. The address pulse supplies an address voltage Vₐ to the address electrode A which forms the discharge cell to be selected from the discharge cells formed by the scan electrode Y in which the voltage of V_{scL1} is supplied. Accordingly, an address discharge is generated by a difference between the voltage of Vₐ supplied to the address electrode A and the voltage of V_{scH} supplied to the scan electrode Y.

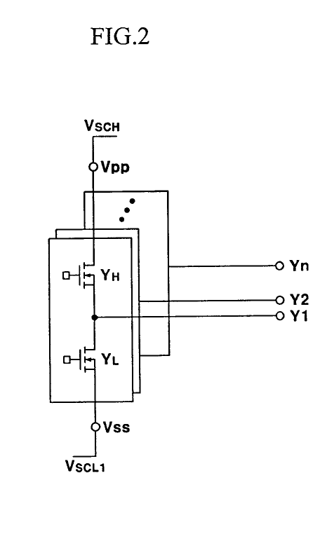

A driving circuit for generating the scan pulse in the address period will be described with reference to FIG. 2. While a switch Y_{H} is turned on and other scan electrodes are maintained at the voltage of V_{scH} for the purpose of supplying the scan pulse to the scan electrode Y, a switch SW1 is turned on to transmit the voltage of V_{scH} to a terminal of Vₛₛ of a scan IC, a switch Y_{L} is turned on to sequentially supply the voltage of V_{scH} to the scan electrode Y, and the scan electrode is selected. Scan electrodes are sequentially scanned from a first scan electrode Y₁ to a last scan electrode Yₙ.

In the above method, it takes longer to supply the scan pulse from the first scan electrode Y₁ to the last scan electrode Yₙ when the single driving scan method is used in a High Definition (HD) PDP which has a lot of scan lines. The width of the scan pulse is reduced in the case of the single scan operation of the HD PDP because the sustain period for performing a display discharge is reduced when the address period is increased. In addition, image quality of the PDP is deteriorated because the address discharge is unstable when the width of the scan pulse is reduced. That is, it is a problem that the cells to be displayed are not turned on.

In the following detailed description, exemplary embodiments of the present invention are shown and described, by way of illustration. As those skilled in the art would recognize, the described exemplary embodiments can be modified in various ways, all without departing from the spirit or scope of the present invention. Accordingly, the drawings and description are to be regarded as illustrative in nature, rather than restrictive.

In the drawings, illustrations of elements having no relation to the present invention have been omitted in order to more clearly present the subject matter of the present invention.

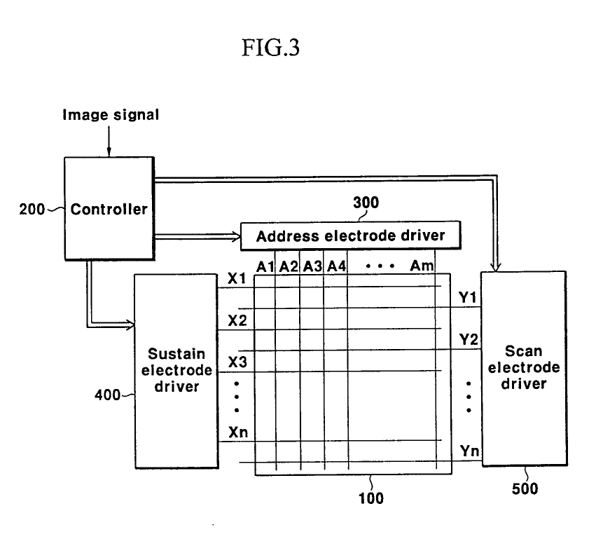

FIG. 3 is a block diagram of a plasma display according to an exemplary embodiment of the present invention.

As shown in FIG. 3, the plasma display according to the exemplary embodiment of the present invention includes a plasma display panel 100, a controller 200, an address driver 300, a sustain electrode driver 400, and a scan electrode driver 500.

The plasma display panel 100 includes a plurality of address electrodes A1 to Am arranged in the column direction, and pairs of a plurality of Y electrodes Y₁ to Yₙ and X electrodes X₁ to Xₙ arranged in parallel in the row direction. The X electrodes X₁ to Xₙ are formed corresponding to the Y electrodes Y₁ to Yₙ. A terminal of each sustain electrode is coupled to the other sustain electrodes in common. The plasma display panel 100 also includes a glass substrate (not illustrated) on which the X and Y electrodes X₁ to Xₙ and Y₁ to Yₙ are arranged, and another glass substrate on which the address electrodes A₁ to Aₘ are arranged. The glass substrates are provided facing each other with discharge spaces therebetween so that the Y electrodes Y₁ to Yₙ and the X electrodes X₁ to Xₙ cross the address electrodes. Discharge cells are formed by the discharge spaces between the address electrodes A₁ to Aₘ and crossing parts of pairs of the Y electrodes Y₁ to Yₙ and the X electrodes X₁ to Xₙ.

The controller 200 receives an external image signal and outputs an address driving control signal, a sustain electrode X driving control signal, and a scan electrode Y driving control signal. The controller 200 operates by dividing a frame into a plurality of subfields, and each subfield has a reset period, an address period, and a sustain period.

The address driver 300 receives the address driving control signal from the controller and supplies a display data signal for selecting discharge cells to be displayed to the respective address electrodes.

The sustain electrode driver 400 receives the sustain electrode X driving control signal from the controller 200 and supplies a driving voltage to the sustain electrode X.

The scan electrode driver 500 receives the scan electrode Y driving control signal from the controller 200 and supplies the driving signal to the scan electrodes Y. The scan electrode driver 500 according to the exemplary embodiment of the present invention divides the plurality of scan electrodes into a plurality of groups, and includes a plurality of driving circuits for driving scan electrodes in the respective groups.

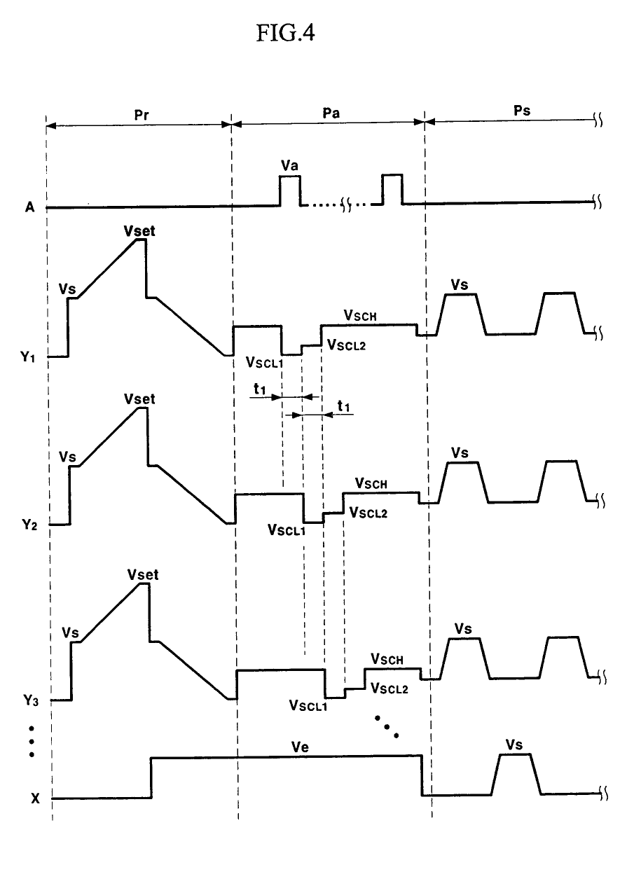

Driving waveforms of the plasma display panel according to the exemplary embodiment of the preset invention will now be described with reference to FIG. 4.

FIG. 4 is a view of driving waveforms of the PDP according to a first exemplary embodiment of the present invention. The address period will be described in detail while descriptions of the reset period and the sustain period have been omitted. The wall charges indicate charges formed on walls (e.g. a dielectric layer) of discharge cells neighboring each electrode and accumulated by the electrodes. Although the wall charges do not actually touch the electrodes, it will be described that the wall charges are “generated,” “formed,” or “accumulated” thereon. Also, a wall voltage represents a potential difference formed on the walls of the discharge cells by the wall charges.

As shown in FIG. 4, the plurality of scan electrodes Y is divided into a first group and a second group respectively having odd scan electrodes and even scan electrodes. A first scan electrode Y1 of the first group is addressed, and a first scan electrode Y2 of the second group is addressed. A second scan electrode Y3 of the first group is addressed, and a second scan electrode Y4 of the second group is addressed. That is, the scan electrodes of the first group and the second group are alternately and sequentially addressed.

In the exemplary embodiment of the present invention, a scan pulse supplied to the scan electrode Y when the address operation is performed has two voltage levels, V_{scL1} and V_{scL2}. Hereinafter, the voltage of V_{scL1} will be referred to as a first scan voltage, and the voltage of V_{scL1} will be referred to as a second scan voltage.

The scan pulse is sequentially supplied to the scan electrodes Y, and the scan electrode to which the scan pulse is not supplied is biased at a non-scan voltage of V_{scH} when a plurality of discharge cells is selected in the address period Pₐ. An address voltage of Vₐ is supplied to the address electrodes A passing on a discharge cell to be selected from the plurality of discharge cells formed by the scan electrodes to which the first scan pulse V_{scL1} of the scan pulse is supplied. Therefore, an address discharge is generated by a difference between the address voltage Vₐ supplied to the address electrodes A and the voltage of VsdL1 supplied to the scan electrodes Y, and a wall voltage caused by the wall charges formed in the scan electrodes Y. The second scan voltage V_{scL2} is supplied to the scan electrodes Y so that enough wall charges can be formed after the address discharge.

The scan pulse selects the scan electrodes Y by sequentially supplying a scan voltage to the scan electrodes Y while other scan electrodes are maintained at the non-scan voltage V_{scH}. The first scan voltage V_{scL1} of the scan pulse selects cells that are turned on and cells that are not turned on in the PDP and generates the address discharge in the cells (addressed cells) that are turned on. The second scan voltage V_{scL2} of the scan pulse forms the wall charges after the address discharge generated by the first scan voltage V_{scL1}. That is, the first scan voltage V_{scL1} together with the address voltage Vₐ supplied to the address electrode A generates the address discharge, and the second scan voltage V_{scL2} of the scan pulse together with the address voltage Vₐ supplied to the address electrode A does not generate the address discharge.

In the first scan electrode Y1 of the first group, while other scan electrodes Y are maintained at the voltage of V_{scH} for a time t1, the scan electrode Y is selected by supplying the first scan voltage V_{scL1} to the scan electrode Y and also supplying the address voltage Vₐ to the address electrode A forming the discharge cell to be selected from the discharge cells formed by the scan electrode Y in which the first scan voltage V_{scL1} is supplied. The address discharge is then generated. The second scan voltage V_{scL2} is supplied to the first scan electrode Y1 of the first group in which the address discharge is generated for the time t1, and the wall charges are properly formed. While the second scan voltage V_{scL2} is supplied to the first scan electrode Y1 of the first group for the time t1, the first scan voltage V_{scL1} and the address voltage Vₐ are supplied to the first scan electrode Y2 of the second group and the address electrode A, and the address discharge is then generated. The second scan voltage V_{scL2} is supplied to the first scan electrode Y2 of the second group, and the wall charges are formed. While the second scan voltage V_{scL2} is supplied to the first scan electrode Y3 of the second group, the first scan voltage V_{scL1} and the address voltage Vₐ are supplied to the second scan electrode Y3 of the first group, and the address discharge is then generated.

The address discharge is alternately performed in the scan electrodes (Y) of the first group and the second group, a time for supplying the scan pulse to at least one scan electrode Y among the plurality of scan electrodes is partly overlapped with a time for supplying the scan pulse to a scan electrode arranged after the scan electrode to which the scan pulse is previously supplied, and therefore a time for performing the address operation is reduced and the wall charges are accumulated more efficiently than with a conventional driving waveform. Accordingly, the address discharge is stably generated, even though the single scan driving method for high definition, which requires a large number of scan electrodes Y, is used.

The time for supplying the scan pulse is a sum of the time t1 for supplying the first scan voltage V_{scL1} and the time t1 for supplying the second scan voltage V_{scL2}. The time t1 for supplying the second scan voltage V_{scL2} is increased to more than that in the address period Pₐ of a conventional plasma display panel. More wall charges are formed after the address discharge, so a sustain-discharge after the address discharge is stably generated. The time corresponds to the width of the scan pulse.

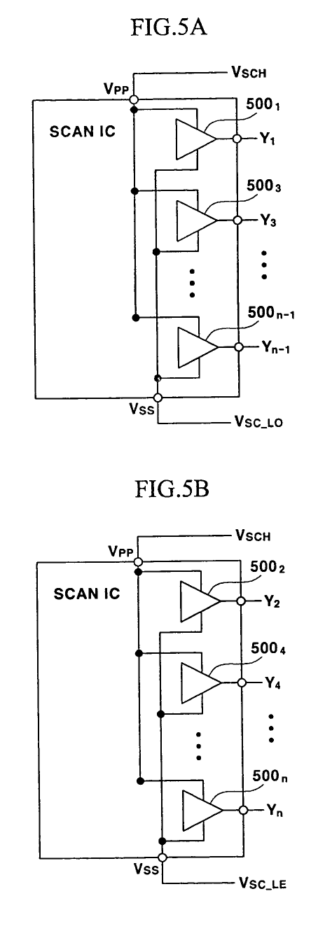

The operation of the driving circuit for generating the driving waveforms in the address period of the PDP of FIG. 4 will now be described with reference to FIG. 5A to FIG. 7.

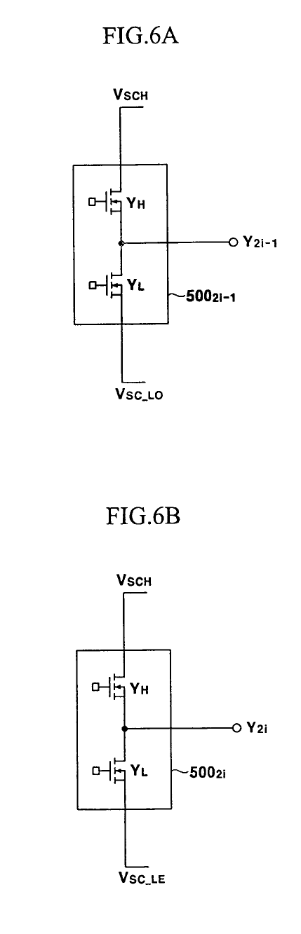

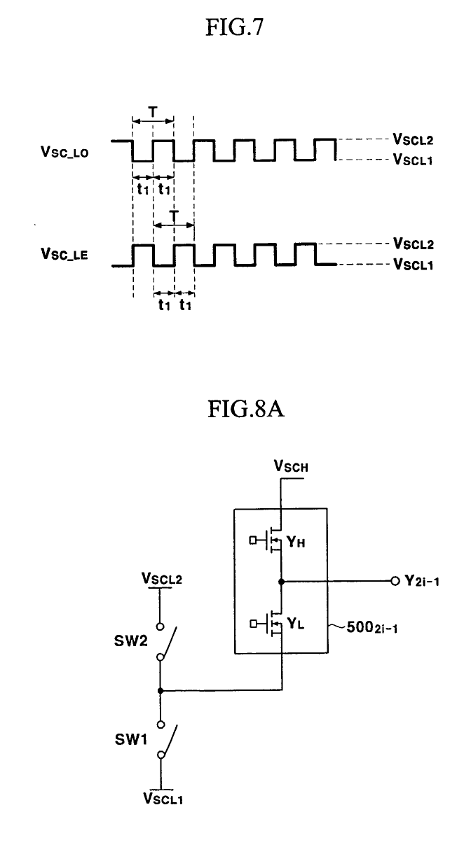

FIG. 5A and FIG. 5B are block diagrams of respective scan driving circuits including the scan ICs for scan electrodes of a first group and a second group according to the first exemplary embodiment of the present invention. FIG. 6A and FIG. 6B respectively are detailed circuit diagrams of the scan ICs of FIG. 5A and FIG. 5B. FIG. 7 is a timing chart of the scan ICs for the scan electrodes of the first group and the second group.

As shown in FIG. 5A and FIG. 5B, the scan driving circuit includes the scan IC. The scan IC includes a plurality of selection circuits 500₁, 500₂, 500₃, 500₄ . . . 500ₙ₋₁, and 500ₙ which are divided into selection circuits 500₁, 500₃, and 500ₙ₋₁ for the scan electrodes of the first group, and selection circuits 500₂, 500₄, and 500ₙ for the scan electrodes for the second group. Note that n is assumed to be an even number. The selection circuits 500₁, 500₂, 500₃, 500₄ . . . 500ₙ₋₁, and 500ₙ are respectively coupled to the scan electrodes Y₁, Y₂, Y₃, Y₄ . . . Yₙ₋₁, and Yₙ.

As shown in FIG. 6A and FIG. 6B, the respective selection circuits include two switches Y_{H} and Y_{L}. The switches Y_{H} and Y_{L} each comprise a field effect transistor having a body diode. The switches Y_{H} and Y_{L} are illustrated as n-channel transistors, and a 2i-1^{th} scan electrode of the first group and a 2i^{th} scan electrode of the second group are respectively illustrated in FIG. 6A and FIG. 6B. As shown in FIG. 6A, the switches Y_{H} and Y_{L} are coupled in series in the scan IC for the scan electrode of the first group, and a node between the switches Y_{H} and Y_{L} is coupled to the 2i-1^{th} scan electrode Y₂ᵢ₋₁. A drain of the switch Y_{H} is coupled to a voltage source for supplying the voltage of V_{scH}. A source of the switch Y_{L} is coupled to a voltage source of V_{sc}_{_{—}}_{L0} for supplying a pulse voltage alternately supplying the voltage of V_{scL1} and the voltage of V_{scL2}, receives a voltage source pulse shown in FIG. 7, and alternately supplies the voltage of V_{scL1} and the voltage of V_{scL2} to the scan electrode of the first group in a period T.

As shown in FIG. 6B, the switches Y_{H} and Y_{L} are coupled in series in the scan IC for the scan electrode of the second group, and a node between the switches Y_{H} and Y_{L} is coupled to the 2i^{th} scan electrode Y₂ᵢ. A drain of the switch Y_{H} is coupled to a voltage source for supplying the voltage of V_{scH}. A source of the switch Y_{L} is coupled to a voltage source of V_{sc}_{_{—}}_{LE} for supplying a pulse voltage alternately supplying the voltage of V_{scL1} and the voltage of V_{scL2}, receives a voltage source pulse shown in FIG. 7, and alternately supplies the voltage of V_{scL1} and the voltage of V_{scL2} to the even scan electrode in a period T.

As shown in FIG. 7, V_{sc}_{_{—}}_{L0} and V_{sc}_{_{—}}_{LE} respectively alternately supply voltage pulses of V_{scL1} and V_{scL2}. The phase of the V_{sc}_{_{—}}_{LO} pulses for the scan electrode of the first group Y_{G1} is opposite to a phase of the V_{sc}_{_{—}}_{LE} pulses for the scan electrode of the second group Y_{G2}. V_{scL1} is a relatively lower voltage and V_{scL2} is a relatively higher voltage. Accordingly, V_{sc}_{_{—}}_{LE} for the scan electrode of the second group supplies the voltage of V_{scL1} to the 2i^{th} scan electrode Y₂ᵢ of the second group when V_{sc}_{_{—}}_{LO} for the scan electrode of the first group supplies the voltage of V_{scL2} to the 2i-1^{th} scan electrode Y₂ᵢ₋₁.

The switch Y_{L} of the scan IC for the scan electrode of the first group is sequentially turned on, and the voltage V_{scL1} and the voltage V_{scL2} are alternately supplied from the first scan electrode Y₁ to the last scan electrode Yₙ₋₁ of the first group in sequence by the pulse supplied from the voltage V_{sc}_{_{—}}_{LO} while the switch Y_{H} of the scan IC for the scan electrode of the first group is turned on in the address period Pₐ and other scan electrodes Y are maintained at the voltage V_{scH}. Note that n is an even number which is assumed to be the last scan electrode among the plurality of scan electrodes. The switch Y_{L} of the scan IC for the scan electrode of the first group is sequentially turned on, and the voltages V_{scL1} and V_{scL2} are alternately supplied from the first scan electrode Y₂ to the last scan electrode Yₙ of the second group when the voltage V_{scL2} is supplied to the first scan electrode Y₁ of the first group while the switch Y_{H} of the scan IC for the scan electrode of the second group is turned on and other scan electrode Y are maintained at the voltage V_{scH}. Accordingly, the address discharge is alternately performed while the scan electrode drive voltage of the first group is partly overlapped with the scan electrode drive voltage of the second group.

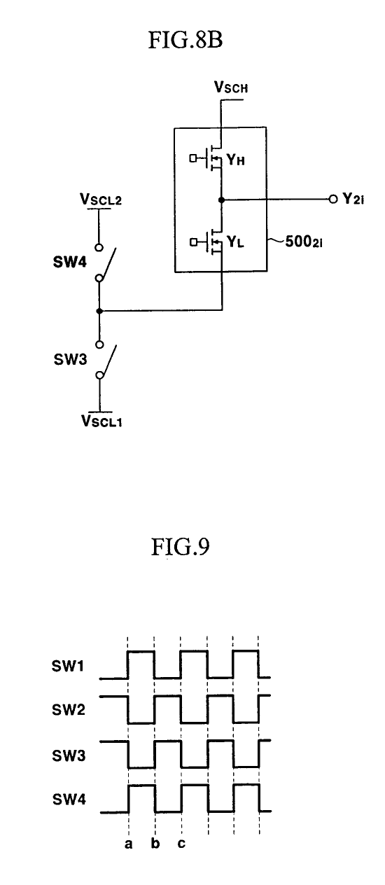

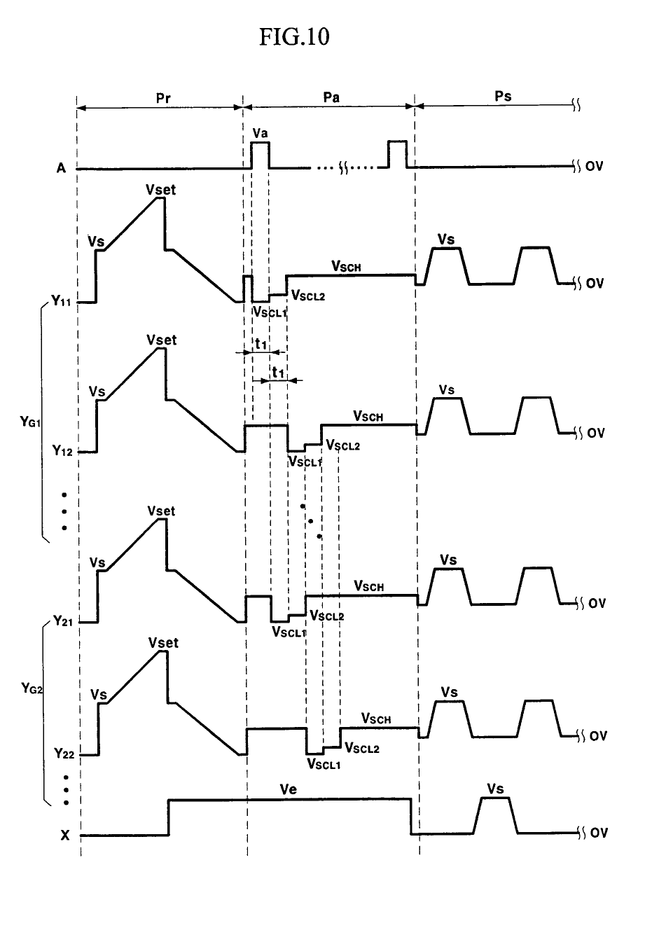

While the scan ICs for the scan electrodes of the first group and the second group are respectively coupled to V_{sc}_{_{—}}_{LO} and V_{sc}_{_{—}}_{LE}, and alternately supply the voltages V_{scL1} and V_{scL2} in the scan driving circuit according to the first exemplary embodiment of the present invention, another exemplary embodiment is shown in FIG. 8A to FIG. 9.

FIG. 8A and FIG. 8B is a view of scan driving circuits including the scan ICs for the scan electrodes of the first group and the second group according to a second exemplary embodiment of the present invention, and FIG. 9 is a timing chart of the scan driving circuits of FIG. 8A and FIG. 8B.

As shown in FIG. 8A and FIG. 8B, the scan driving circuits according to the second exemplary embodiment of the present invention corresponds to the scan driving circuits according to the first exemplary embodiment except for further providing first to fourth switches SW1 to SW4.

As shown in FIG. 8A, the scan driving circuit includes the scan IC for the scan electrode of the first group and switches SW1 and SW2. The switches SW1 and SW2 are coupled to each other in series, and respectively coupled to the voltage V_{scL1} and the voltage V_{scL2}.

As shown in FIG. 8B, the scan driving circuit includes the scan IC for the scan electrode of the second group and switches SW3 and SW4. The switches SW3 and SW4 are coupled to each other in series, and respectively coupled to the first scan voltage V_{scL1} and the second scan voltage V_{scL2}.

The operation of the scan driving circuits of FIG. 8A and FIG. 8B will now be described, focusing on the operation of the switches SW1 to SW4.

As shown in FIG. 9, the switch SW1 is turned on, and the first scan voltage V_{scL1} is supplied to the first scan electrode Y1 of the first group at a time a.

The switch SW1 is turned off and the switch SW2 is turned on, and the second scan voltage V_{scL2} is supplied to the first scan electrode Y1 of the first group at a time b. The switch SW3 is also turned on and the first scan voltage V_{scL1} is supplied to the first scan electrode Y2 of the second group at the time b.

The switch SW3 is turned off and the switch SW4 is turned on, and the second scan voltage V_{scL2} is supplied to the first scan electrode Y2 of the second group at a time c. The switch SW2 is also turned off and the switch SW1 is turned on, and the second scan voltage V_{scL2} is supplied to the scan electrode Y3 of the first group at the time c.

The first scan voltage V_{scL1} and the second scan voltage V_{scL2} are alternately supplied while the drives of the scan electrodes of the first and the second group are partly overlapped for a predetermined time. That is, the first scan voltage V_{scL1} and the second scan voltage V_{scL2} are supplied to the scan electrodes by turning on/off the switches for supplying the first scan voltage V_{scL1} and the second scan voltage V_{scL2}.

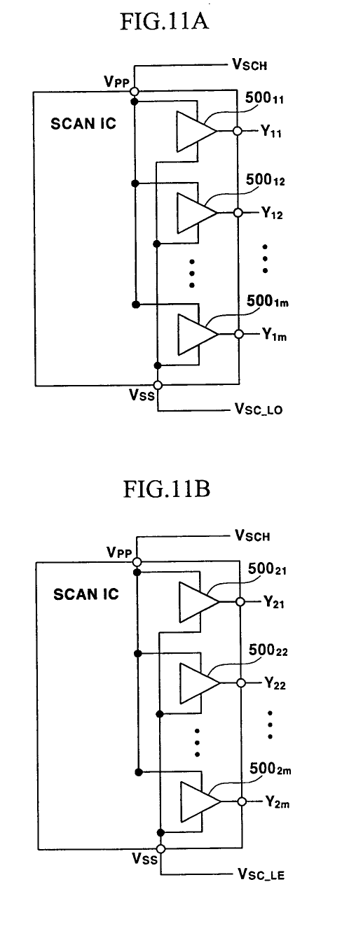

Odd scan electrodes and even scan electrodes of the plurality of scan electrodes are divided into respective groups, and the scan electrodes are sequentially addressed in the respective groups. A period for supplying the scan pulse of a scan electrode is partly overlapped with a period for supplying the scan pulse of a neighboring scan electrode. An address discharge is generated when the first scan voltage V_{scL1} and the address voltage Vₐ are supplied to the 2i-1^{th} scan electrode and the address electrode. An erroneous discharge is generated when the address voltage Vₐ is supplied, discharge priming particles are greatly generated by the address discharge, and the second scan voltage V_{scL2} is supplied to the 2i-1th scan electrode. Therefore, the groups are formed to leave spaces of some electrodes so that a selected scan electrode of a group can not be adjacent to a scan electrode of another group, and therefore the erroneous discharge can be prevented, which will be shown with reference to FIG. 10.

FIG. 10 is a view of driving waveforms of the PDP according to the second exemplary embodiment of the present invention. The plurality of scan electrodes Y are divided into two groups which are represented as a first group Y_{G1} and a second group Y_{G2} in the address period Pₐ of FIG. 10.

As shown in FIG. 10, the driving waveforms of the plasma display panel according to the second exemplary embodiment of the present invention correspond to the driving waveforms according to the first exemplary embodiment of the present invention except for dividing the plurality of scan electrodes into the first group Y_{G1} of the scan electrodes Y arranged on the upper part of the plasma display panel and the second group Y_{G2} of the scan electrodes Y arranged on the lower part of the plasma display panel.

That is, the plurality of scan electrodes Y are divided into the first group Y_{G21} and the second group Y_{G2} according to an order that the scan voltage is supplied. A first scan electrode Y₁₁ of the first group Y₂₁ is addressed, and a first electrode Y₂₁ of the second group Y_{G2} is addressed. A second scan electrode Y₁₂ of the first group Y_{G1} is addressed, and a second scan electrode Y₂₂ of the second group Y_{G2} is addressed. That is, the scan electrodes of the first group Y_{G1} and the second group Y_{G2} are alternately addressed.

The address discharge is generated by supplying the first scan voltage V_{scL1} and the address voltage Vₐ to the first scan electrode Y₁₁ of the first group Y_{G1} and the address electrode A for a time t1. The wall charges are formed by supplying the second scan voltage V_{scL2} to the first scan electrode Y₁₁ in which the address discharge is generated for the time t1. The address discharge is generated by supplying the first scan voltage V_{scL1} and the address voltage Vₐ to the first scan electrode Y₂₁ of the second group Y_{G2} and the address electrode while the second scan voltage V_{scL2} is supplied to the first scan electrode Y₁₁ of the first group Y_{G1} for the time t1. The wall charges are formed by supplying the second scan voltage V_{scL2} to the first scan electrode Y₂₁ of the second group Y_{G2}. As described, the address discharge is also generated by supplying the first scan voltage V_{scL1} and the address voltage Vₐ to the second scan electrode Y₁₂ of the first group Y_{G1} and the address electrode A while the second scan voltage is supplied to the first scan electrode Y₂₁ of the second group Y_{G2}.

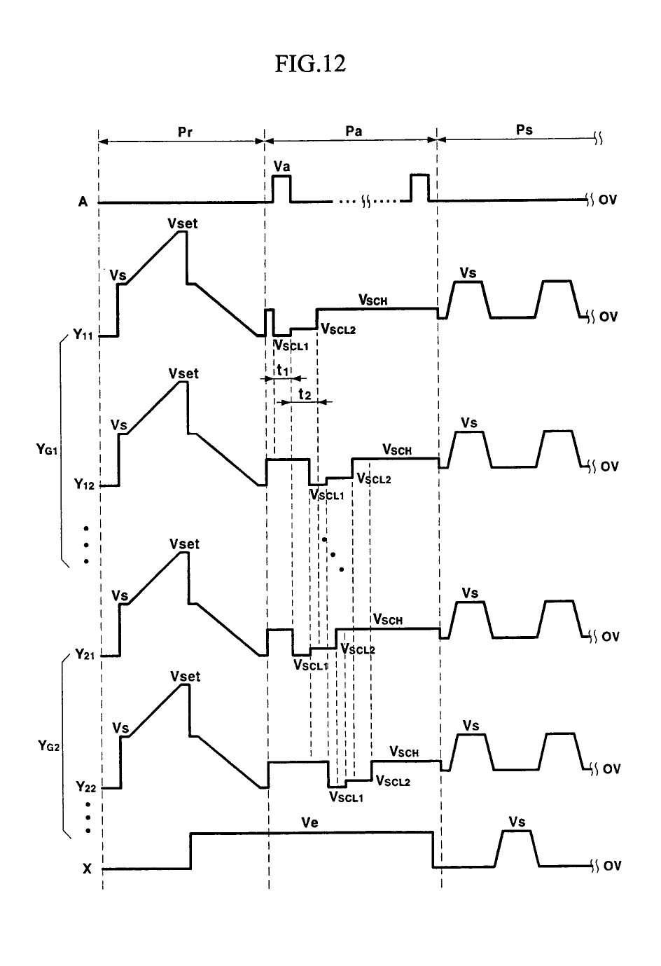

The operation of the driving circuit for generating the address driving waveforms of the plasma display panel shown in FIG. 10 will be described with reference to FIG. 11A and FIG. 11B.

FIG. 11A and FIG. 11B respectively are detailed circuit diagrams of the scan driving circuits including the scan ICs for scan electrodes of the first group and the second group according to a third exemplary embodiment of the present invention.

As shown in FIG. 11A and FIG. 11B, the driving circuit according to the third exemplary embodiment of the present invention corresponds to that shown in FIG. 5A and FIG. 5B except that the selection circuits for the scan electrodes of the first group Y_{G1} are coupled to the scan electrodes in the upper part of the panel and the selection circuits for the scan electrodes of the second group Y_{G2} are coupled to the scan electrodes in the lower part of the panel.

The scan driving circuit includes the scan IC. The scan IC includes a plurality of the selection circuits 500₁₁, 500₁₂ . . . and 500₁ₘ, and 500₂₁, 500₂₂ . . . and 500₂ₘ which are divided into the selection circuits 500₁₁, 500₁₂ . . . and 500₁ₘ for the scan electrodes of the first group Y_{G1} and the selection circuits 500₂₁, 500₂₂ . . . and 500₂ₘ for the scan electrode of the second group Y_{G2}. The selection circuits 500₁₁, 500₁₂ . . . and 500₁ₘ, and the selection circuits 500₂₁, 500₂₂ . . . and 500₂ₘ are respectively coupled to the scan electrodes Y₁₁, Y₁₂ . . . and Y₁ₘ, and Y₂₁, Y₂₂ . . . and Y₂ₘ (herein, it is assumed that m is n/2).

As shown in FIG. 11A, in the scan IC for the scan electrode of the first group Y_{G1}, switches Y_{H} and Y_{L} are coupled to each other in series as shown in FIG. 6A, and a node between the switches Y_{H} and Y_{L} is coupled to the i^{th} scan electrode Y₁ᵢ of the first group Y_{G1}. A drain of the switch Y_{H} is coupled to the voltage V_{scH}, and a source of the switch Y_{L} is coupled to the voltage V_{scLO} for supplying a pulse voltage alternately supplying the voltage V_{scL1} and the voltage V_{sc}_{_{—}}_{L2}. The scan IC receives the pulses shown in FIG. 7 and alternately supplies the voltages V_{scL1} and V_{scL2} to the scan electrodes of the first group Y_{G1}.

As shown in FIG. 11B, in the scan IC for the scan electrode of the second group Y_{G2}, the switches Y_{H} and Y_{L} are coupled to each other in series as shown in FIG. 6B, and a node between the switches Y_{H} and Y_{L} is coupled to the i^{th} scan electrode Y₂ᵢ of the second group. The drain of the switch Y^{H} is coupled to the voltage V_{scH}, and the source of the switch Y_{L} is coupled to the voltage V_{sc}_{_{—}}_{LE} for alternately supplying pulsed voltages of V_{scL1} and V_{scL2}. The scan IC receives the pulses shown in FIG. 7 and alternately supplies the voltages V_{scL1} and V_{scL2} to the scan electrodes of the second group Y_{G2} for the period T.

The voltage V_{sc}_{_{—}}_{LE} for the scan electrode of the second group Y_{G2} supplies the pulsed voltage V_{scL1}to the i^{th} scan electrode Y₂ᵢ of the second group Y_{G2} when the scan electrode of the first group Y_{G1} supplies the pulsed voltage V_{scL2} to the i^{th} scan electrode Y₁ᵢ of the first group Y_{G1}. Accordingly, some parts of drive of the scan electrodes of the first group and the second group are overlapped with each other, and the electrodes are alternately addressed. Herein, i denotes a predetermined scan electrode.

The scan pulse can be supplied to the scan electrode in the like manner as described in FIG. 8A and FIG. 9.

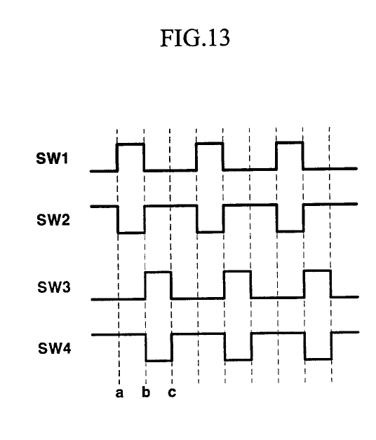

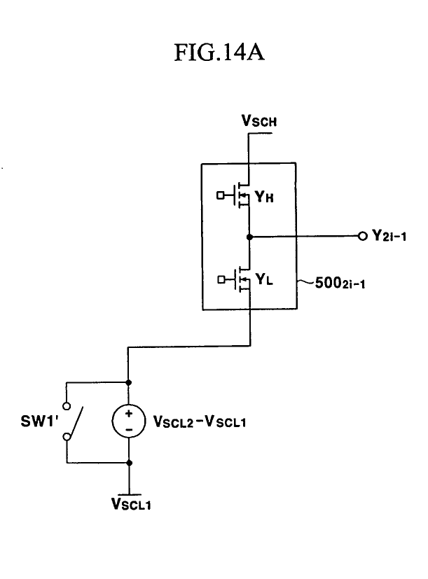

While the times t1 for supplying the first scan voltage V_{scL1} and the second scan voltage V_{scL2} correspond to each other in the driving waveform according to the first exemplary embodiment of the present invention, another exemplary embodiment will be described with reference to FIG. 12 and FIG. 13.

FIG. 12 is a view of driving waveforms of the PDP according to the third exemplary embodiment of the present invention and FIG. 13 is a timing chart of the scan driving circuits of FIG. 8A and FIG. 8B for generating the driving waveforms of FIG. 12 according to the second exemplary embodiment.

As shown in FIG. 12, a time t2 for supplying the second scan voltage V_{scL2} is longer than a time t1 for supplying the first scan voltage V_{scL1}. Accordingly, the wall charges are accumulated after the address discharge caused by the first scan voltage V_{scL1} more than the wall charges in the driving waveforms of the plasma display panel according to the first exemplary embodiment.

The scan pulse is supplied to the scan electrode in the like manner described in FIG. 5A to FIG. 9. The pulse time t2 for supplying the second scan voltage V_{scL2} is longer than the time t1 for supplying the first scan voltage V_{scL1} when the pulses are supplied as shown in FIG. 7, and the times for turning on a second and a fourth switches are longer than the times for turning on a first and a third switches as shown in FIG. 13 when the first and the second scan voltages V_{scL1} and V_{scL2} are supplied using the switches as shown in FIG. 8A and FIG. 8B.

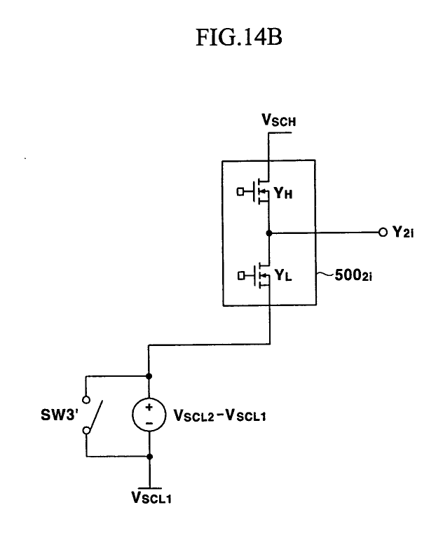

FIG. 14A and FIG. 14B respectively are detailed circuit diagrams of the scan driving circuits including the scan ICs for scan electrodes of the first group and the second group according to a fourth exemplary embodiment of the present invention.

The fourth exemplary embodiment of the present invention is similar to the second embodiment and differs from the second embodiment in that one of the switches for each scan driving circuit has been eliminated.

As shown in FIG. 14A, the scan driving circuit includes the scan IC for the scan electrode of the first group and switch SW1′. The switch SW1′ is connected in parallel to a voltage source V_{scL2}-V_{scL1} and to a voltage source V_{scL1}. When the switch SW1′ is opened, the voltage V_{scL2} is inputted to the scan IC. When the switch SW1′ is closed, the voltage V_{scL1} is inputted to the scan IC. Thus, the circuit of FIG. 14A produces the same result as the circuit of FIG. 8A but needs only one switch.

As shown in FIG. 14B, the scan driving circuit includes the scan IC for the scan electrode of the second group and switch SW3′. The switch SW3′ is connected in parallel to a voltage source V_{scL2}-V_{scL1} and to a voltage source V_{scL1}. When the switch SW3′ is opened, the voltage V_{scL2} is inputted to the scan IC. When the switch SW3′ is closed, the voltage V_{scL1} is inputted to the scan IC. Thus, the circuit of FIG. 14B produces the same result as the circuit of FIG. 8A but needs only one switch.

While the scan electrodes of the first group and the second group Y_{G1} and Y_{G2} are respectively addressed in sequence in the second and the third exemplary embodiments of the present invention, they can also be addressed irregularly. However, the scan electrodes of the first group Y_{G1} and the second group Y_{G2} must be alternately addressed.

While the plurality of scan electrodes Y are divided into the scan electrodes in the upper part and the lower part of the plasma display panel in the second and the third exemplary embodiment of the present invention, the groups can be determined by irregularly selecting the scan electrodes of the respective groups leaving a space therebetween so that they are not neighboring each other.

In the high definition panel, a period for supplying the scan pulse to the first scan electrode Y among the plurality of scan electrodes Y is partly overlapped with a period for supplying the scan pulse to the second electrode Y which leaves a space with the first scan electrode when the scan pulse is sequentially supplied to the scan electrode Y in the address period. Therefore, enough wall charges are accumulated in a short scan pulse period for generating the address discharge, and the erroneous discharge occurring when the scan pulses are partly overlapped in neighboring scan electrodes is prevented.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents. For example, In the exemplary embodiments discussed in detail above, the scan electrodes have been divided into two groups. However, the present invention is not limited thereto.

According to the present invention, the address discharge is stably generated when the single scan driving method is used in the HD PDP having a large number of scan electrodes. Accordingly, insufficient discharges are prevented in the plasma display panel.

The plurality of scan electrodes is divided into a plurality of groups, the address operation is alternately performed in the respective groups, the scan pulses supplied to the respective electrodes are partly overlapped with each other, and a time for performing the address operation is therefore reduced. The erroneous discharge generated when the scan pulses between the neighboring scan electrodes are partly overlapped with each other is prevented when the plurality of scan electrodes are divided into groups including more than three neighboring scan electrodes.

1. A method of driving a Plasma Display Panel (PDP), the method comprising:
forming discharge cells with a plurality of scan electrodes and a plurality of address electrodes arranged in a direction perpendicular to the scan electrodes;
dividing the plurality of scan electrodes into a plurality of groups including a first group and a second group;
supplying, during an address period, a first scan pulse to at least one scan electrode among the scan electrodes of the first group;
supplying, during the address period, a second scan pulse succeeding the first scan pulse to at least one scan electrode among the scan electrodes of the first group;
supplying the first scan pulse to at least one scan electrode among the scan electrodes of the second group while the second scan pulse is being supplied to at least one scan electrode among the scan electrodes of the first group; and
supplying the second scan pulse succeeding the first scan pulse to at least one scan electrode among the scan electrodes of the second group.

2. The method of claim 1, wherein the second scan pulse has a pulse width equal to a pulse width of the first scan pulse.

3. The method of claim 1, wherein the second scan pulse has a pulse width greater than a pulse width of the first scan pulse.

4. The method of claim 1, wherein the first and second groups respectively include a plurality of neighboring scan electrodes.

5. The method of claim 1, wherein the scan electrodes of the first group are even numbered scan electrodes, and the scan electrodes of the second group are odd numbered scan electrodes.

6. The method of claim 1, wherein the first scan pulse together with an address pulse supplied to the address electrode is sufficient to generate an address discharge and wherein the second scan pulse together with the address pulse supplied to the address electrode is insufficient to generate the address discharge.

7. A Plasma Display Panel (PDP) comprising:
a display panel including a plurality of scan electrodes and a plurality of address electrodes, the plurality of scan electrodes being divided into a plurality of groups including a first group and a second group; and
a plurality of selection circuits respectively coupled to the scan electrodes of the first and the second groups among the plurality of scan electrodes;
wherein the respective selection circuits of the first group among the plurality of selection circuits coupled to the scan electrodes of the first group among the plurality of scan electrodes include a first switch coupled between a first voltage source adapted to supply a first voltage and the scan electrode, and a second switch coupled between the scan electrode and a second voltage source adapted to selectively supply one of a second and a third voltage; and
wherein the second switch is adapted to selectively supply one of the second and third voltages to the scan electrode upon the scan electrode being selected, and the first switch is adapted to supply the first voltage to the scan electrode upon the scan electrode not being selected.

8. The PDP of claim 7, wherein the respective selection circuits among the plurality of selection circuits coupled to the respective scan electrodes of the second group among the plurality of scan electrodes each comprise:
a third switch coupled between a third voltage source adapted to supply a fourth voltage and the scan electrode; and
a fourth switch coupled between the scan electrode and a fourth voltage source adapted to supply a one of a fifth and a sixth voltage; and
wherein the third switch voltage source is adapted to selectively supply one of the fifth and sixth voltages to the scan electrode upon the scan electrode being selected, and the fourth switch is adapted to supply the fourth voltage to the scan electrode upon the scan electrode not being selected.

9. The PDP of claim 8, wherein a first time period for supplying the third voltage to at least one scan electrode among the scan electrodes of the first group partially overlaps a second time period for supplying the fifth voltage to at least one scan electrode among the scan electrodes of the second group.

10. The PDP of claim 9, wherein the first time period is equal to the second time period.

11. The PDP of claim 9, wherein the first time period is greater than the second time period.

12. The PDP of claim 8, wherein the second voltage is equal to the fifth voltage and the third voltage is equal to the sixth voltage.

13. The PDP of claim 7, wherein the second voltage and the fifth voltage together with an address voltage supplied to the address electrode is sufficient to generate a discharge and wherein the third voltage and the sixth voltage together with the address voltage supplied to the address electrode is insufficient to generate the discharge.

14. The PDP of claim 13, wherein the first group and the second group respectively comprise even numbered scan electrodes and odd numbered scan electrodes.

15. The PDP of claim 13, wherein the first group and the second group respectively comprise a plurality of neighboring scan electrodes.

16. A Plasma Display Panel (PDP) comprising:
a display panel including a plurality of scan electrodes and a plurality of address electrodes, the plurality of scan electrodes being divided into a plurality of groups including a first group and a second group, the respective groups including a plurality of neighboring scan electrodes;
a selection circuit of a first group adapted to be coupled to the scan electrode of the first group among the plurality of scan electrodes;
a selection circuit of a second group adapted to be coupled to the scan electrode of the second group among the plurality of scan electrodes;
a first driving circuit adapted to supply a first voltage to the scan electrode of a discharge cell to be turned on among the scan electrodes of the first group via the selection circuit of the first group, and to supply a second voltage which is higher than the first voltage to the scan electrode during an address period; and
a second driving circuit adapted to supply the first voltage to the scan electrode of a discharge cell to be turned on among the scan electrodes of the second group via the selection circuit of the second group, and to supply the second voltage to the scan electrode during the address period;
wherein a time period for supplying the second voltage to the scan electrode of the discharge cell to be turned on among the scan electrodes of the first group partially overlaps a time period for supplying the first voltage to the scan electrodes of the scan electrode of the discharge cell to be turned on among the scan electrodes of the second group.

17. The PDP of claim 16, wherein the respective selection circuits of the first group and the second group each comprise:
a first switch having a first terminal coupled to the scan electrode; and
a second switch adapted to be coupled between a first voltage source for supplying the third voltage higher than the second voltage and the scan electrode;
wherein the respective first and second driving circuits include the third switch adapted to be coupled between a second terminal of the first switch and a second voltage source adapted to supply the first voltage, and the fourth switch adapted to be coupled between the second terminal of the first switch and a third voltage source adapted to supply the second voltage;
wherein the second switch is adapted to be turned on to apply the third voltage to the scan electrode upon the scan electrode not being selected; and
wherein the first switch is adapted to be turned on and the third and fourth switches are adapted to be alternately turned on to alternately apply one of the first and second voltages to the scan electrode of the first and second groups upon the scan electrode being selected.

18. The PDP of claim 17, wherein a first time period for turning on the fourth switch upon the scan electrode of the first group being selected partially overlaps a second time period for turning on the third switch upon the scan electrode of the second group being selected.

19. The PDP of claim 18, wherein the first time period is equal to the second time period.

20. The PDP of claim 18, wherein the first time period is greater than the second time period.

21. The PDP of claim 16, wherein the first voltage together with the address voltage supplied to an address electrode of the discharge cell to be turned on is sufficient to generate a discharge and wherein the second voltage together with the address voltage is insufficient to generate the discharge.

22. The PDP of claim 16, wherein the respective selection circuits of the first seconds group each comprise:
the first switch having the first terminal coupled to the scan electrode; and
the second switch adapted to be coupled between the first voltage source for supplying the third voltage higher than the second voltage and the scan electrodes;
wherein the respective first and second driving circuits include a third voltage source adapted to be coupled between the second terminal of the first switch and the second voltage source adapted to supply the first voltage such that the third switch supplies a voltage obtained by subtracting the second voltage from the first voltage, and the third switch adapted to be coupled to the third voltage source;
wherein the second switch is adapted to be turned on to apply the third voltage to the scan electrode upon the scan electrode not being selected; and
wherein the first switch is adapted to be turned on and the third switch is adapted to be alternately turned on and turned off to alternately apply one of the first and second voltages to the scan electrode of the first and second groups upon the scan electrode being selected.

23. A method of driving a Plasma Display Panel (PDP), the method comprising:
forming discharge cells with a plurality of scan electrodes and a plurality of address electrodes arranged in a direction perpendicular to the scan electrodes;
supplying, during an address period, a first scan pulse to at least a first scan electrode;
supplying, during the address period, a second scan pulse succeeding the first scan pulse to at least the first scan electrode;
supplying the first scan pulse to at least a second scan electrode while the second scan pulse is being supplied to at least the first scan electrode; and
supplying the second scan pulse succeeding the first scan pulse to at least the second scan electrode.

24. The method of claim 23, wherein the second scan pulse has a pulse width equal to a pulse width of the first scan pulse.

25. The method of claim 23, wherein the second scan pulse has a pulse width greater than a pulse width of the first scan pulse.

26. The method of claim 23, wherein the first scan pulse together with an address pulse supplied to the address electrode is sufficient to generate an address discharge and wherein the second scan pulse together with the address pulse supplied to the address electrode is insufficient to generate the address discharge.

27. A Plasma Display Panel (PDP) comprising:
a display panel including a plurality of scan electrodes and a plurality of address electrodes; and
a plurality of selection circuits respectively coupled to the plurality of scan electrodes;
wherein first selection circuits of the plurality of selection circuits coupled to first scan electrodes of the plurality of scan electrodes include a first switch coupled between a first voltage source adapted to supply a first voltage and the scan electrode, and a second switch coupled between the scan electrode and a second voltage source adapted to selectively supply one of a second and a third voltage; and
wherein the second switch is adapted to selectively supply one of the second and third voltages to the scan electrode upon the scan electrode being selected, and the first switch is adapted to supply the first voltage to the scan electrode upon the scan electrode not being selected.

28. The PDP of claim 27, wherein second selection circuits of the plurality of selection circuits coupled to second scan electrodes of the plurality of scan electrodes each comprise:
a third switch coupled between a third voltage source adapted to supply a fourth voltage and the scan electrode; and
a fourth switch coupled between the scan electrode and a fourth voltage source adapted to supply a one of a fifth and a sixth voltage; and
wherein the third switch voltage source is adapted to selectively supply one of the fifth and sixth voltages to the scan electrode upon the scan electrode being selected, and the fourth switch is adapted to supply the fourth voltage to the scan electrode upon the scan electrode not being selected.

29. The PDP of claim 28, wherein a first time period for supplying the third voltage to the first scan electrode partially overlaps a second time period for supplying the fifth voltage to the second scan electrode.

30. The PDP of claim 29, wherein the first time period is equal to the second time period.

31. The PDP of claim 29, wherein the first time period is greater than the second time period.

32. The PDP of claim 29, wherein the second voltage is equal to the fifth voltage and the third voltage is equal to the sixth voltage.

33. The PDP of claim 28, wherein the second voltage and the fifth voltage together with an address voltage supplied to the address electrode is sufficient to generate a discharge and wherein the third voltage and the sixth voltage together with the address voltage supplied to the address electrode is insufficient to generate the discharge.

34. A Plasma Display Panel (PDP) comprising:
a display panel including a plurality of scan electrodes and a plurality of address electrodes;
a first selection circuit adapted to be coupled to a first scan electrode of the plurality of scan electrodes;
a second selection circuit adapted to be coupled to a second scan electrode of the plurality of scan electrodes;
a first driving circuit adapted to supply a first voltage to the first scan electrode of a discharge cell to be turned on via the first selection circuit, and to supply a second voltage which is higher than the first voltage to the scan electrode during an address period; and
a second driving circuit adapted to supply the first voltage to the second scan electrode of a discharge cell to be turned on via the selection circuit of the second group, and to supply the second voltage to the scan electrode during the address period;
wherein a time period for supplying the second voltage to the first scan electrode of the discharge cell to be turned on partially overlaps a time period for supplying the first voltage to the second scan electrode of the discharge cell to be turned on.

35. The PDP of claim 34, wherein the first and second selection circuits each comprise:
a first switch having a first terminal coupled to the scan electrode; and
a second switch adapted to be coupled between a first voltage source for supplying the third voltage higher than the second voltage and the scan electrode;
wherein the respective first and second driving circuits include the third switch adapted to be coupled between a second terminal of the first and a second voltage source adapted to supply the first voltage, and the fourth switch adapted to be coupled between the second terminal of the first switch and a third voltage source adapted to supply the second voltage;
wherein the second switch is adapted to be turned on to apply the third voltage to the scan electrode upon the scan electrode not being selected; and
wherein the first switch is adapted to be turned on and the third and fourth switches are adapted to be alternately turned on to alternately apply one of the first and second voltages to the first scan and second electrode upon the scan electrode being selected.

36. The PDP of claim 35, wherein a first time period for turning on the fourth switch upon the first scan electrode being selected partially overlaps a second time period for turning on the third switch upon the second scan electrode being selected.

37. The PDP of claim 36, wherein the first time period is equal to the second time period.

38. The PDP of claim 36, wherein the first time period is greater than the second time period.

39. The PDP of claim 34, wherein the first voltage together with the address voltage supplied to an address electrode of the discharge cell to be turned on is sufficient to generate a discharge and wherein the second voltage together with the address voltage is insufficient to generate the discharge.

40. The PDP of claim 34, wherein the respective selection circuits of the first seconds group each comprise:
the first switch having the first terminal coupled to the scan electrode; and
the second switch adapted to be coupled between the first voltage source for supplying the third voltage higher than the second voltage and the scan electrode;
wherein the respective first and second driving circuits comprise a third voltage source adapted to be coupled between the second terminal of the first switch and the second voltage source adapted to supply the first voltage such that the third switch supplies a voltage obtained by subtracting the second voltage from the first voltage, and the third switch adapted to be coupled to the third voltage source;
wherein the second switch is adapted to be turned on to apply the third voltage to the scan electrode upon the scan electrode not being selected; and
wherein the first switch is adapted to be turned on and the third switch is adapted to be alternately turned on and turned off to alternately apply one of the first and second voltages to the first scan and second electrode upon the scan electrode being selected.
